(19) United States
(12) Patent Application Publication
(10) Pub. No.: US 2019/0361627 A1
(43) Pub. Date: Nov. 28, 2019

(54) MEMORY DEVICE, CONTROL METHOD THEREOF AND RECORDING MEDIUM

(71) Applicant: SK hynix Inc., Gyeonggi-do (KR)

(72) Inventors: Ching-Chung LAI, Hsinchu County (TW); Lian-Chun LEE, Hsinchu County (TW)

(21) Appl. No.: 16/358,121

(22) Filed: Mar. 19, 2019

(30) Foreign Application Priority Data
May 24, 2018 (TW) 107117648

(51) Int. Cl. G06F 3/06; G06F 12/02

(52) U.S. Cl. CPC G06F 3/0659; G06F 3/0658; G06F 3/0604; G06F 3/0673; G06F 12/0292

(57) ABSTRACT

A control method of a memory device may include: (a) reading a read request of a host; (b) determining, by the processor, whether a logical address corresponding to the read request of the host is present in a cache; and (c) generating, by the processor, a data read command according the read request when the determination result of (b) indicates that the logical address corresponding to the read request is present in the cache, and transferring, by the processor, the data read command to one of the plurality of memory channels which corresponds to the physical address, in order to process the data read command.

### CROSS-REFERENCES TO RELATED APPLICATION

The present application claims priority under 35 U.S.C. § 119(a) to Taiwan application number 107117648, filed on May 24, 2018, in the Taiwan Intellectual Property Office, which is incorporated herein by reference in its entirety.

### BACKGROUND

### 1. Technical Field

Various embodiments of the present description generally relate to an electronic device. Particularly, the embodiments relate to a memory device, a control method thereof and a recording medium.

### 2. Related Art

Semiconductor devices are classified into volatile memory devices and nonvolatile memory devices. The volatile memory device may lose data stored therein when power is lost or interrupted, while the nonvolatile memory device may retain data stored therein regardless of whether the power is supplied or not. Electronic devices such as wearable devices and mobile devices including smart phones and tablet computers may have various application programs having different functions, which are downloaded and executed therein. Due to the widespread use of these electronic devices, the user demand for storage media of the electronic devices is continuously increasing. Since data stored in the nonvolatile memory device are not lost even after power is removed and the nonvolatile memory device has a small volume and low power consumption, the nonvolatile memory device such as a flash memory-based storage device is applied in quantity to such electronic devices.

When an electronic device executes an application program to display a photograph or play multimedia such as audio or video, the electronic device often requests a storage device to read a large amount of data within a short period of time. A memory device controller of the storage device may generate a command according to the read request of the electronic device (or host device), and execute the generated command. The controller may include a command queue for storing commands, and the commands stored in the command queue may be sequentially outputted to the memory device of the storage device to perform data reading operations. When a relatively large delay is present between data reading operations in a random read situation, the delay may not only have an influence on the entire reading efficiency, but also cause an abnormal response of an application program, in the case that the electronic device executes the application program.

### SUMMARY

Various embodiments are directed to a memory device which can be applied to a device with a memory and can implement a method for improving various random reading efficiencies, a control method thereof and a recording medium. For example, it is possible to improve the efficiencies of random reading operations performed by the memory device, using a method of preferentially processing a data read command in the memory device.

In an embodiment, a control method of a memory device may include: (a) reading a read request of a host; (b) determining, by a processor, whether a logical address corresponding to the read request of the host is present in a cache; and (c) generating, by the processor, a data read command according to the read request by translating the logical address into a physical address based on address mapping data in the cache, when the logical address corresponding to the read request is present in the cache, and transferring, by one or more of memory channel controllers respectively corresponding to a plurality of memory channels, the data read command to one of the plurality of memory channels which corresponds to the physical address, in order to process the data read command.

In an embodiment, the control method may further include (d) when the logical address corresponding to the read request is not present in the cache, finding, by the processor based on the logical address, an address mapping table section corresponding to the logical address, generating, by the processor, a mapping table read command for the address mapping table section, and transferring, by one or more of the memory channel controllers, the mapping table read command to one of the memory channels which corresponds to the address mapping table section, in order to process the mapping table read command.

In an embodiment, the control method may further include (e) determining, by each memory channel controllers corresponding to each memory channels, whether there is an arbitrary data read command to be preferentially processed, and preferentially processing, by each memory channel controller, the data read command when both of the data read command and the mapping table read command are determined to be processed by each memory channel controllers.

In an embodiment, each of the memory channels may have first and second command queues. The (c) may include storing the data read command in the first command queue of the memory channel corresponding to the physical address, and transferring, by each memory channel controller, the data read command to the memory channel corresponding to the physical address in order to process the data read command. The (d) may include storing the mapping table read command in the second command queue of the memory channel corresponding to the address mapping table section, and transferring, by each memory controller, the mapping table read command to the memory channel corresponding to the address mapping table section in order to process the mapping table read command.

In an embodiment, (e) may include determining, by each memory channel controller, whether there is an arbitrary data read command to be preferentially processed, by determining whether the first command queue is empty, processing, by each memory channel controller, the command in the first command queue when the first command queue is not empty, and processing, by each memory channel controller, the command in the second command queue when the first command queue is empty.

In an embodiment, each of the memory channels may include a command queue. The (c) may include giving a first priority to the data read command, storing the data read command in the command queue of the memory channel corresponding to the physical address, and transferring, by each memory channel controller, the data read command to the memory channel corresponding to the physical address in order to process the data read command. The (d) may include giving a second priority to the mapping table read command, storing the mapping table read command in the command queue of the memory channel corresponding to the address mapping table section, and transferring, by each memory channel controller, the mapping table read command to the memory channel corresponding to the address mapping table section in order to process the mapping table read command.

In an embodiment, (e) may include determining, by each memory channel controller, whether there is an arbitrary data read command to be preferentially processed by determining whether the command with the first priority is present in the command queue, processing, by each memory channel controller, the command with the first priority in the command queue when the command with the first priority is present in the command queue, and processing, by each memory channel controller, the command with the second priority in the command queue when the command with the first priority is not present in the command queue.

In an embodiment, (d) may further include the of setting the read request in a first state. The control method may further include (f) reading the read request in the first state through (a) after the mapping table read command is processed due to the (d), (g) generating a first data read command corresponding to the read request in the first state through the (b) and the (c), (h) transferring, by each memory channel controller, the first data read command to one of the memory channels which corresponds to the physical address, in order to process the first data read command, and (i) additionally setting the read request in a second state.

In an embodiment, the (d) may further include transferring the read request to one queue. The control method may further include (j) reading the host read request of the queue through the (a) after the mapping table read command is processed, (k) generating a first data read command corresponding to the host read request of the queue through the (b) and the (c), and (I) transferring, by each memory channel controller, the first data read command to one of the memory channels which corresponds to the physical address, in order to process the first data read command.

In an embodiment, there is provided a recording medium that records a program code for controlling a memory device to execute the control method according to any one of the embodiments.

In an embodiment, a memory device may include: a cache; an address translator configured to determine whether a logical address corresponding to a host read request is present in the cache, generate a data read command according to the host read request by translating the logical address into a physical address based on address mapping data in the cache, when the logical address corresponding to the host read request is present in the cache, and transfer the data read command to one of a plurality of memory channels which corresponds to the physical address, in order to process the data read command; and a plurality of memory channel controllers each corresponding to one of the memory channels and configured to process a command.

In an embodiment, when the logical address corresponding to the host read request is not present in the cache, the address translator may find an address mapping table section corresponding to the logical address based on the logical address, generate a mapping table read command according to the host read request, and transfer the mapping table read command to one of the memory channels which corresponds to the address mapping table section, in order to process the mapping table read command.

In an embodiment, each of the memory channel controllers may determine whether there is an arbitrary data read command to be preferentially processed, and preferentially process the data read command when both of the data read command and the mapping table read command determined to be processed by the memory channel controller.

In an embodiment, each of the memory channels may have first and second command queues. The address translator may store the data read command in the first command queue of the memory channel corresponding to the physical address, and transfers the data read command to the memory channel corresponding to the physical address in order to process the data read command. The address translator may store the mapping table read command in the second command queue of the memory channel corresponding to the address mapping table section, and transfers the mapping table read command to the memory channel corresponding to the address mapping table section in order to process the mapping table read command.

In an embodiment, the memory channel controller may determine whether there is an arbitrary data read command to be preferentially processed, by determining whether the first command queue is empty, process the command in the first command queue when the first command queue is not empty, and process the command in the second command queue when the first command queue is empty.

In an embodiment, each of the memory channels may include a command queue. The address translator may give a first priority to the data read command, store the data read command in the command queue of the memory channel corresponding to the physical address, and transfer the data read command to the memory channel corresponding to the physical address in order to process the data read command. The address translator may give a second priority to the mapping table read command, store the mapping table read command in the command queue of the memory channel corresponding to the address mapping table section, and transfer the mapping table read command to the memory channel corresponding to the address mapping table section in order to process the mapping table read command.

In an embodiment, the memory channel controller may determine whether there is an arbitrary data read command to be preferentially processed, by determining whether a command with the first priority is present in the command queue, process the command with the first priority in the command queue when the command with the first priority is present in the command queue, and process the command with the second priority in the command queue when the command with the first priority is not present in the command queue.

### BRIEF DESCRIPTION OF THE DRAWINGS

FIG. 1 is a block diagram illustrating a memory device in accordance with an embodiment.

FIG. 2 is a block diagram illustrating a memory device controller in accordance with an embodiment.

FIG. 3A is a flowchart illustrating a control method of a memory device in accordance with an embodiment.

FIG. 3B is a flowchart illustrating an embodiment of step S40 in FIG. 3A.

FIG. 3C is a flowchart illustrating a control method of a memory device in accordance with an embodiment.

FIG. 4 is a block diagram illustrating a memory device in accordance with an embodiment.

FIG. 5 is a block diagram illustrating an embodiment of a memory device controller which can be applied to FIG. 4.

FIG. 6 illustrates a process of processing a plurality of random read requests, based on an embodiment which is implemented according to the control method of the memory device in FIGS. 3A (or 3B) and 3C by applying the memory device controller of FIG. 5.

FIG. 7 is a block diagram illustrating an embodiment of the memory device controller which can be applied to FIG. 4.

### DETAILED DESCRIPTION

Various embodiments of the present invention are described below in more detail with reference to the accompanying drawings. We note, however, that the present invention may be embodied in different forms and variations, and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention. It is noted that reference to “an embodiment” does not necessarily mean only one embodiment, and different references to “an embodiment” are not necessarily to the same embodiment(s).

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present. Communication between two elements, whether directly or indirectly connected/coupled, may be wired or wireless, unless stated or the context indicates otherwise.

The terminology used herein is for the purpose of describing particular embodiments only and is not intended to be limiting of the present invention.

As used herein, singular forms may include the plural forms as well and vice versa, unless the context clearly indicates otherwise.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Hereinafter, the various embodiments of the present invention will be described in detail with reference to the attached drawings.

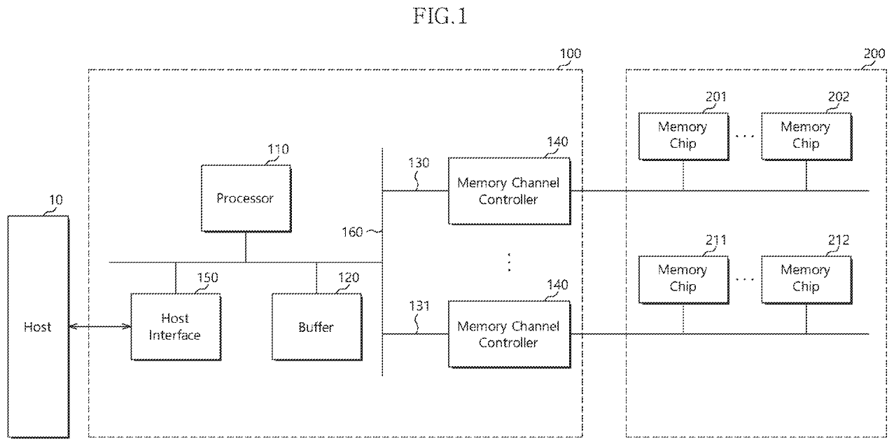

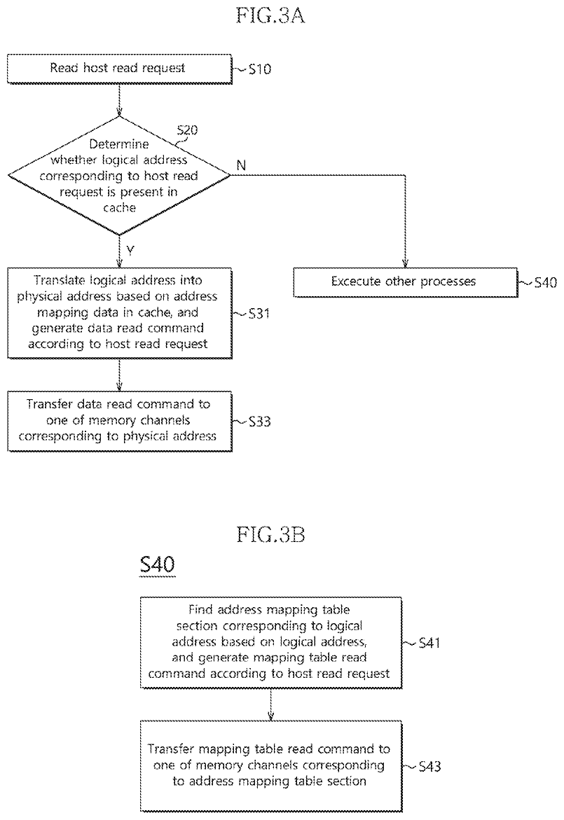

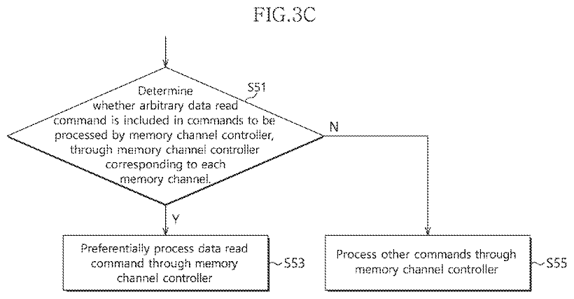

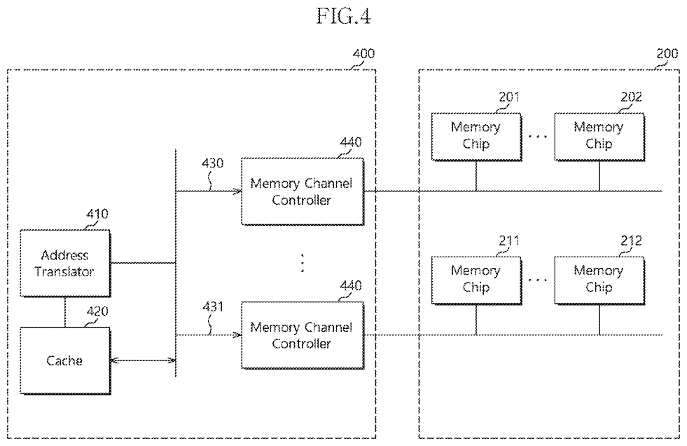

FIG. 1 illustrates a memory device in accordance with an embodiment. The memory device of FIG. 1 can implement a control method of FIG. 3A, 3B or 3C, and implement a method for improving various random reading efficiencies through the control method. The control method will be described below in detail. For example, it is possible to improve the efficiencies of random reading operations performed by the memory device, using a method of preferentially processing a data read command in the memory device.

As illustrated in FIG. 1, the memory device includes a memory device controller 100 and a memory 200.

The memory device controller 100 includes a processor 110, a buffer 120, a plurality of memory channels 130 and 131, and a plurality of memory channel controllers 140, each corresponding to each of the memory channels 130 and 131.

The buffer 120 may be implemented with a volatile memory or nonvolatile memory.

The memory 200 includes a plurality of memory chips 201, 202, 211 and 212. For example, each of the memory chips 201, 202, 211 and 212 is a flash memory such as a NOR-type memory or NAND-type memory. However, the present embodiment is not limited to such an example.

The memory device controller 100 may receive a read request from a host 10 by communicating with the host 10 through a host interface 150. The memory device controller 100 generates a command corresponding to the read request of the host 10, and transfers the generated command to the memory channel controller 140 of the memory channel 130 or 131 corresponding to the command.

The memory channel controller 140 serves to control one or more among the memory chips 201, 202, 211 and 212. For example, the memory channel controller 140 transfers a data read command to any one among the memory chips 201, 202, 211 and 212, and transfers data to the memory device controller 100, for example, the buffer 120, the data read according to the data read command.

The memory device controller 100 transfers data requested by the host 10 to the host 10. In FIG. 1, the plurality of memory channel controllers 140 simultaneously operate in a parallel manner.

In addition, the processor 110 is electrically coupled to the memory channels 130 and 131, for example, through a bus-bar 160. However, the present embodiment is not limited to the above-described example. For example, each of the memory channel controllers 140 may be implemented with a logical circuit or programmable circuit, or implemented in software and executed by the processor 110.

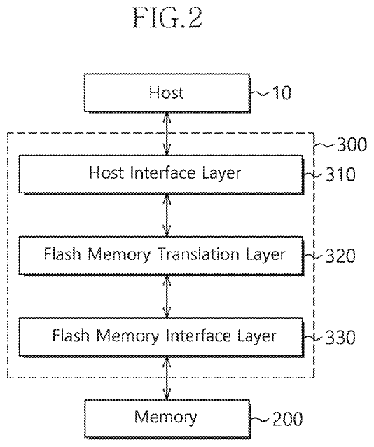

FIG. 2 is a block diagram illustrating an embodiment of the memory device controller 300. FIG. 2 illustrates a structure in the case that the memory device controller 300 is implemented in firmware or software.

Referring to FIGS. 1 and 2, the memory device controller 300 includes a host interface layer 310, a flash memory translation layer 320 and a flash memory interface layer 330.

The host interface layer 310 serves as an interface between the host 10 and the memory device controller 300 while communicating with the host 10.

The flash memory translation layer 320 serves to manage read, write and erase operations. The flash memory translation layer 320 also serves to translate a logical address (for example, a logical block address or logical page address) into a physical address (for example, a physical block address or physical page address) corresponding to the memory chip 201, 202, 211 or 212 of the memory 200.

The flash memory interface layer 330 serves to perform communication between the flash memory translation layer 320 and the memory 200. For example, the flash memory interface layer 330 transfers a command from the flash memory translation layer 320 to the memory 200.

The memory device controller 300 illustrated in FIG. 2 may be implemented through the hardware structure of FIG. 1.

The flash memory translation layer 320 may refer to and maintain an address mapping table when translating a logical address into a physical address. Since the address mapping table includes a large amount of data, the flash memory translation layer 320 stores a section of the address mapping table in a cache. When the corresponding relationship between a physical address and a logical address, which is required for translation, is not present in the cache, the flash memory translation layer 320 may update the section of the address mapping table in the cache and generate a mapping table read command. In addition, when a certain memory product, for example, an embedded multi-media card (eMMC) or another memory product is applied, the address mapping table is stored in a memory of the memory product. The present embodiment is not limited to such an example.

FIG. 3A is a flowchart illustrating a control method of the memory device in accordance with an embodiment. The embodiment illustrated in FIG. 3A can be applied to a device with a memory, and implement a method for improving various random reading efficiencies.

Referring to FIGS. 1 and 3A, the control method of the memory device, illustrated in FIG. 3A, includes the following steps.

At step S10, the memory device controller 100 reads a read request of the host 10. For example, the memory device controller 100 implements one or more host command queues using the buffer 120 or a part of a memory, and the host command queue serves to receive a read request from the host 10. The memory device controller 100 reads the read request of the host 10.

At step S20, the memory device controller 100 determines whether a logical address corresponding to the read request of the host 10 is present in the cache. For example, the processor 110 determines whether the logical address corresponding to the host read request is present in the address mapping table section which is currently stored in the buffer 120.

When the logical address corresponding to the host read request is present in the cache (that is, “Y” at step S20), the processor 110 translates the logical address into a physical address based on the address mapping table data in the cache, and generates a data read command according to the host read request, at step S31.

At step S33, the processor 110 transfers the data read command to one of the plurality of memory channels 130 and 131, which corresponds to the physical address, in order to process the data read command.

When the logical address corresponding to the host read request is not present in the cache (that is, “N” at step S20), the processor 110 executes other processes at step S40. For example, the processor 110 may issue a mapping table read command to update the contents of the cache, or issue a request signal to update the contents of the address mapping table section in the cache.

FIG. 3B illustrates an embodiment of step S40 in FIG. 3A. In FIG. 3B, step S40 may include steps S41 and S43.

When the logical address corresponding to the read request of the host is not present in the cache, the processor 110 finds an address mapping table section of the address mapping table, which corresponds to the logical address, based on the logical address, and generates a mapping table read command according to the host read request, at step S41.

At step S43, the processor 110 transfers the mapping table read command to one of the memory channels 130 and 131, which corresponds to the address mapping table section, in order to process the mapping table read command.

For example, the address mapping table may include a plurality of address mapping table sections, and the address mapping table sections may be stored in the plurality of memory chips 201, 202, 211 and 212 of the memory device.

For example, the processor 110 finds the address mapping table section required for step S41 among the plurality of address mapping table sections stored in the memory chips 201, 202, 211 and 212, through a search, operation or table lookup method, for example. In addition, the mapping table read command includes the physical address (for example, start address) of the found address mapping table section, and the contents of the found address mapping table section are temporarily stored in the cache after the mapping table read command is executed.

In the memory device illustrated in FIG. 1, when mapping table read commands and data read commands which correspond to a series of random read requests from the host 10 are disproportionately processed by any one memory channel 130, for example, a disconnection or delay is likely to continuously occur while finally read data are transferred to the host 10.

In accordance with an embodiment of the present disclosure, the efficiencies of the random reading operations performed by the memory device may be improved by adding steps of FIG. 3C to the operation of preferentially processing the data read command as described with reference to FIG. 3A. The steps of FIG. 3C may be applied to one memory channel controller 140 corresponding to each of the memory channels 130 and 131. Each memory channel controller 140 included in the memory device of FIG. 1 may individually performs steps of FIG. 3C, and thus determine whether there is an arbitrary data read command to be preferentially processed. When both of the data read command and the mapping table read command are determined to be processed by the memory channel controller 140, the memory channel controller 140 preferentially processes the data read command.

Referring to FIG. 3C, steps S51 to S55 are performed, by the memory channel controller 140, after step S33 or S40 is performed by the processor 110 as described with reference to FIGS. 3A and 3B.

The memory channel controller 140 corresponding to each of the memory channels 130 and 131 determines whether an arbitrary data read command is to be processed by the memory channel controller 140, at step S51.

When a data read command is determined to be processed by the memory channel controller 140 (that is, “Y” at step S51), the memory channel controller 140 preferentially processes the data read command at step S53.

When no data read command is determined to be processed by the memory channel controller 140 (that is, “N” at step S51), the memory channel controller 140 processes other commands among the commands to be processed, at step S55. The other commands may include a mapping table read command. For example, when both of the data read command and the mapping table read command are to be processed, the memory channel controller 140 preferentially processes the data read command. However, the other commands may further include commands to be processed by the memory channel controller 140, and the present embodiment is not limited to such an example.

Therefore, host read requests from the host 10 can be processed by continuously repeating the steps of FIGS. 3A to 3C. According to the method of FIG. 3C, the memory channel controller 140 corresponding to each of the memory channels 130 and 131 executes a command based on the method that preferentially processes a data read command. Therefore, although mapping table read commands and data read commands which correspond to a series of random read requests from the host 10 are disproportionately processed by any one memory channel 130, the possibility that a disconnection or delay will occur while read data are transferred to the host 10 may be significantly reduced, or no disconnection or no delay may occur.

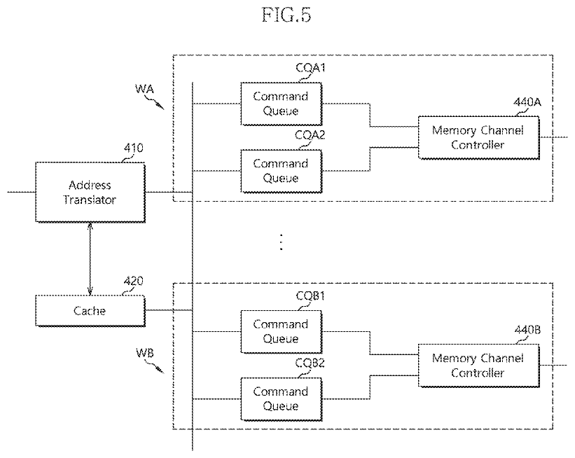

FIG. 4 is a block diagram illustrating a memory device in accordance with an embodiment.

As illustrated in FIG. 4, the memory device includes a memory device controller 400, and the memory device controller 400 includes an address translator 410, plurality of memory channels 430 and 431, a cache 420 and a plurality of memory channel controllers 440, each corresponding to each of the memory channels 430 and 431.

The address translator 410 serves to determine whether a logical address corresponding to a host read request is present in the cache 420.

When the logical address corresponding to the host read request is present in the cache 420, the address translator 410 translates the logical address into a physical address based on address mapping data of the cache 420, generates a data read command according to the host read request, and transfers the data read command to one of a plurality of memory channels 430 and 431, which corresponds to the physical address, in order to process the data read command.

When the logical address corresponding to the host read request is not present in the cache 420, the address translator 410 finds an address mapping table section corresponding to the logical address based on the logical address, generates a mapping table read command according to the host read request, and transfers the mapping table read command to one of the memory channels 430 and 431, which corresponds to the address mapping table section, in order to process the mapping table read command.

Each of the memory channel controllers 440 corresponds to one of the memory channels 430 and 431 to process a command, and determines whether there is an arbitrary data read command to be preferentially processed.

When both of a data read command and a mapping table read command are determined to be processed by the memory channel controller 440, the memory channel controller 440 preferentially processes the data read command.

The embodiment of FIG. 4 may be used to implement the method illustrated in FIG. 3A, 3B or 3C. In the embodiment of FIG. 4, the address translator 410 may be used to implement the steps of the method illustrated in FIG. 3A or 3B, and the memory channel controller 440 may be used to implement the steps of the method illustrated in FIG. 3C.

In the case of the methods of FIGS. 3A to 3C and the memory device controller of FIG. 4, the method for preferentially processing a data read command may be implemented in different manners. Hereafter, a plurality of embodiments will be listed and described.

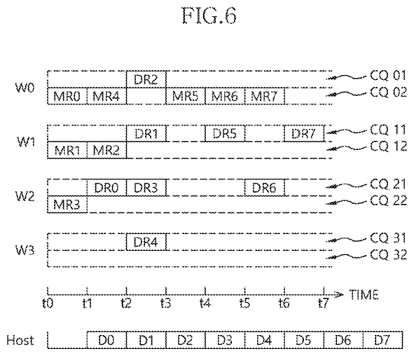

FIG. 5 is a block diagram illustrating an embodiment which can be applied to the memory device controller 400 of FIG. 4.

In the embodiment of the memory device controller 400 illustrated in FIG. 5, a plurality of memory channels WA and WB has first command queues CQA1 and CQB1, and second command queues CQA2 and CQB2 corresponding to the memory channels WA and WB, respectively. The memory channels WA and WB include memory channel controllers 440A and 440B, respectively, which receive commands from the first and second command queues CQA1, CQB1, CQA2, and CQB2.

Each of the memory channel controllers (for example, 440A) may process a command of the first command queue CQA1 prior to a command of the second command queue CQA2.

According to the arrangement of the command queues, the address translator 410 of FIG. 4 stores a data read command in the first command queue CQA1 or CQB1 of the memory channel WA or WB corresponding to a physical address and transfers the data read command to the memory channel WA or WB corresponding to the physical address, in order to process the data read command, thereby implementing step S33 of FIG. 3A.

In addition, the address translator 410 of FIG. 4 stores a mapping table read command in the second command queue CQA2 or CQB2 of the memory channel WA or WB corresponding to a first address mapping table section, and transfers the mapping table read command to the memory channel WA or WB corresponding to the first address mapping table section, in order to process the mapping table read command, thereby implementing step S43 of FIG. 3B.

In an embodiment, the memory channel controller 440A or 440B determines whether the first command queue CQA1 or CQB1 is empty, based on steps S51, S53 and S55 of FIG. 3C, and thus determines whether there is an arbitrary data read command to be preferentially processed. When the first command queue CQA1 or CQB1 is not empty, the memory channel controller 440A or 440B processes a command in the first command queue CQA1 or CQB1. On the other hand, when the first command queue CQA1 or CQB1 is empty, the memory channel controller 440A or 440B processes a command in the second command queue CQA2 or CQB2.

FIG. 6 illustrates a process of processing a plurality of random read requests, based on an embodiment which is implemented according to the control method of the memory device in FIGS. 3A to 3C by applying the memory device controller 400 of FIG. 5. In the embodiment illustrated in FIG. 6, the memory device controller has four memory channels W0 to W3, two command queues CQ01 and CQ02 are arranged in each of the memory channels W0 to W3, and commands included in the queues are represented by blocks.

The embodiment of FIG. 6 is based on the supposition that host read requests RQ1 to RQ8 for eight data D0 to D7 are transferred from the host 10. The memory device controller of FIG. 5 may implement an embodiment according to the method of FIGS. 3A to 3C, in order to process the eight host read requests.

In the above-described embodiment, the corresponding relationships between physical addresses and logical addresses, which are required for the eight host read requests, are not present in the cache. Therefore, the memory device controller of FIG. 5 generates eight mapping table read commands MR0 to MR7 based on steps S41 and S43, and stores the mapping table read commands MR0 to MR7 in the corresponding memory channels W0 to W2 through the address translator 410.

In the command queue CQ02 of the memory channel W0 illustrated at the top of FIG. 6, the mapping table read commands MR0, MR4, MR5, MR6 and MR7 wait to be sequentially processed by the memory channel controller 440 of the memory channel W0 from left to right. The memory channel controllers 440 of the memory channels W0 to W3 simultaneously operate in a parallel manner.

Referring to FIG. 6, the memory channel controllers 440 of the memory channels W0 to W2 individually process the mapping table read commands MR0, MR1 and MR3 at the same time, in a period of time from t0 to t1.

After the mapping table read commands MR0, MR1 and MR3 are executed or after time t1, the cache of the memory device controller of FIG. 5 includes an updated address mapping table section, and the address translator 410 re-reads the host read requests RQ0, RQ1 and RQ3 by performing step S10 of FIG. 3A, and determines a cache hit by performing step S20. Thus, the address translator 410 further performs step S31 to generate data read commands DR0, DR1 and DR3 corresponding to the host read requests RQ0, RQ1 and RQ3, using the corresponding relationship between physical addresses and logical addresses of the host read requests RQ0, RQ1 and RQ3.

Since the physical addresses corresponding to the data read commands DR0 and DR3 correspond to the memory chip of the memory channel W2, the address translator 410 stores the data read commands DR0 and DR3 in a command queue CQ21 of the memory channel W2. Since the physical address corresponding to the data read command DR1 corresponds to the memory chip of the memory channel W1, the address translator 410 stores the data read command DR1 in a command queue CQ11 of the memory channel W1. In FIG. 6, the address mapping table sections in the cache may be updated with time differences, after the mapping table read commands MR0, MR1 and MR3 have been executed. Therefore, the data read commands DR0, DR1 and DR3 corresponding to the mapping table read commands MR0, MR1 and MR3 may be generated at different times.

As illustrated in FIG. 6, the memory channel controllers of the memory channels W0 and W1 individually process the mapping table read commands MR4 and MR2, and the memory channel controller of the memory channel W2 individually processes the data read command DR0 to read the data D0, in a period of time from t1 to t2. Therefore, as illustrated at the bottom of FIG. 6, the memory device controller of FIG. 5 may output the data D0 to the host.

After time t2, the address translator 410 generates the data read commands DR4 and DR2 by further performing steps S31 and S33, and stores the data read commands DR4 and DR2 in the command queue CQ01 of the memory channel W0 and the command queue CQ11 of the memory channel W1, respectively.

As illustrated in FIG. 6, the memory channel controller 440 of the memory channel W0 determines that the command queue CQ01 is not empty, in a period of time from t2 to t3. Thus, the memory channel controller 440 of the memory channel W0 preferentially processes the data read command DR2, and delays processing the mapping table read command MR5 in the command queue CQ02. The memory channel controllers 440 of the memory channels W1, W2 and W3 read the data D1, D3 and D4 by individually processing the data read commands DR1, DR3 and DR4. Therefore, as illustrated at the bottom of FIG. 6, the memory device controller of FIG. 5 may output the data D1 to D4 to the host after time t2.

As illustrated in FIG. 6, the memory channel controller 440 of the memory channel W0 determines that the command queue CQ01 is empty, and thus processes the mapping table read commands MR5, MR6 and MR7 in the command queue CQ02, in a period of time from t3 to t6. Therefore, after time t4, the address translator 410 generates the data read commands DR5 to DR7 by further performing steps S31 and S33, and stores the data read commands DR5 to DR7 in the command queue CQ11 and the command queue CQ21. The memory channel controllers 440 of the memory channels W1 and W2 read the data D5 to D7 by individually processing the data read commands DR5 to DR7. Therefore, as illustrated at the bottom of FIG. 6, the memory device controller of FIG. 5 may output the data D5 to D7 to the host after time t6.

As described with reference to the embodiment illustrated in FIG. 6, the memory device controller of FIG. 5 executes commands through the method for preferentially processing a data read command. Therefore, although mapping table read commands and data read commands corresponding to a series of random read requests from the host 10 are disproportionately processed by any one memory channel (for example, the memory channel W0), the possibility that a disconnection or delay will occur while read data are transferred to the host 10 can be significantly reduced, or no disconnection or no delay may occur.

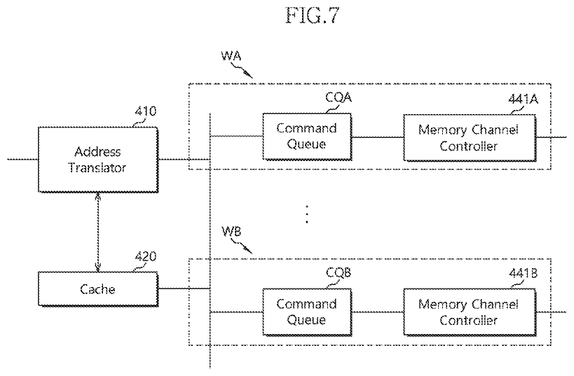

FIG. 7 is a block diagram illustrating an embodiment which can be applied to the memory device controller of FIG. 4.

As illustrated in FIG. 7, memory channels WA and WB in accordance with the present embodiment have command queues CQA and CQB corresponding to the respective memory channels WA and WB. The memory channels WA and WB may include memory channel controllers 441A and 441B to receive commands from the respective command queues. The commands in the command queue (for example, the command queue CQA1) of each memory channel controller (for example, the memory channel controller 441A) may have different processing priorities.

The present embodiment may implement the method based on FIGS. 3A to 3C. Based on steps S31 and S33 of FIG. 3A, the address translator 410 may give a first priority to a data read command, store the data read command in the command queue CQA or CQB of a memory channel WA or WB corresponding to a physical address, and transfer the data read command to the memory channel WA or WB corresponding to the physical address, in order to process the data read command. Based on steps S41 and S43 of FIG. 3B, the address translator 410 may give a second priority to a mapping table read command, store the mapping table read command in the command queue CQA or CQB of a memory channel WA or WB corresponding to a first address mapping table section, and transfer the mapping table read command to the memory channel WA or WB corresponding to the first address mapping table section, in order to process the mapping table read command.

In the embodiment of FIG. 7, based on steps S51, S53 and S55 of FIG. 3C, the memory channel controllers 441A and 441B may determine whether a command with the first priority is present in the respective command queues CQA and CQB and thus determine whether there is an arbitrary data read command to be preferentially processed. When a command with the first priority is present in the command queue CQA or CQB, the corresponding memory channel controller 441A or 441B processes the command with the first priority in the command queue CQA or CQB. On the other hand, when no command with the first priority is present in the command queue CQA or CQB, the corresponding memory channel controller 441A or 441B processes a command with the second priority in the command queue CQA or CQB.

In the embodiment illustrated in FIG. 7, the memory device controller of FIG. 4 executes commands through the method for preferentially processing a data read command. Thus, although mapping table read commands and data read commands which correspond to a series of random read requests from the host 10 are disproportionately processed by any one memory channel W0, for example, the possibility that a disconnection or delay will occur while read data are transferred to the host 10 can be significantly reduced, or no disconnection or delay may occur.

In addition, the host read request in step S41 of FIG. 3B may be processed in a different manner, and a data read command may be generated through this process.

In an embodiment, step S40 of FIG. 3A may further include setting the host read request in a first state indicating that the host read request is waiting for a processing of translating a logical address into a physical address through the address translator 410 of FIG. 4.

After the mapping table read command is processed, the address translator 410 performs step S10 of FIG. 3A to read the host read request in the first state, performs steps S20, S31 and S33 of FIG. 3A to generate the data read command corresponding to the host read request in the first state, and transfers the data read command to one of the memory channels 430 and 431, which corresponds to the physical address, in order to process the data read command.

At this time, the host read request may be further set in a second state indicating that the translation of the logical address into the physical address is completed for the host read request, which is now waiting for a process of reading data from an area of the memory chip which corresponds to the physical address. Therefore, the memory device controller of FIG. 4 may easily perform the subsequent process of transferring the read data to the host.

In another embodiment, step S40 may further include transferring the host read quest to a waiting queue indicating that the host read request is waiting for a process of translating a logical address into a physical address through the address translator 410 of FIG. 4. After a mapping table read command is processed, the address translator 410 may perform step S10 to read the host read request in the waiting queue, perform steps S20, S31 and S33 to generate a data read command corresponding to the host read request in the waiting queue, and transfer the data read command to one of the memory channels, which corresponds to the physical address, in order to process the data read command.

In addition, some among the above described embodiments suggest a recording medium which records a program code for driving the memory device controller to execute the control method of the memory device illustrated in FIG. 1, 2, 4, 5 or 7, for example. The control method includes any one of the embodiments based on the methods of FIGS. 3A to 3C or a combination thereof. For example, a program code for implementing steps S10 to S40 of FIG. 3A, steps S41 and S43 of FIG. 3B or steps S51 to S55 of FIG. 3C may include one or more programs or program modules. The program codes of the modules may be operated in cooperation or executed in arbitrary suitable order or in parallel to each other. When the program code is executed, the memory device controller may execute any one of the embodiments of the control method of the memory device based on FIGS. 3A to 3C. Examples of the recording medium may include firmware, ROM, RAM, memory card, optical data storage medium, magnetic data storage medium or other arbitrary storage media or memories, and the present embodiment is not limited to such examples.

Furthermore, in the embodiment related to the memory device described with reference to FIG. 1, 4, 5 or 7, one or more of the processor 110, the address translator 410 and the memory channel controller 140, 440, 440A, 440B, 441A or 441B or combinations thereof may be implemented with one or more circuits such as processors and digital signal processors, implemented with one or more circuits such a microcontroller and a programmable integrated circuit such as a field programmable gate array (FPGA) or application specific integrated circuit (ASIC), or implemented with a dedicated circuit or module. Furthermore, the address translator or the memory channel controller may be implemented through a software method, for example, scheduling, threading, program modules or other software methods. However, the present embodiment is not limited to such examples.

The above-described embodiments provide a memory device which can be applied to a device with a memory and implement a method for improving various random reading efficiencies, a control method thereof, and a recording medium. For example, it is possible to improve the efficiency of random reading operations performed by the memory device, using the method of preferentially processing a data read command in the memory device.

While various embodiments have been described above, it will be understood to those skilled in the art that the embodiments described are examples only. Accordingly, the memory device, the control method thereof and the recording medium, which have been described herein, should not be limited based on the described embodiments.

1. A control method of a memory device, comprising:
(a) reading a read request of a host;
(b) determining, by the processor, whether a logical address corresponding to the read request of the host is present in a cache; and
(c) generating, by the processor, a data read command according to the read request by translating the logical address into a physical address based on address mapping data in the cache when the logical address corresponding to the read request is present in the cache, and transferring, by the processor, the data read command to one of the plurality of memory channels which corresponds to the physical address, in order to process the data read command.

2. The control method according to claim 1, further comprising (d), when the logical address corresponding to the read request is not present in the cache:
finding, by the processor based on the logical address, an address mapping table section corresponding to the logical address,
generating, by the processor, a mapping table read command for the address mapping table section, and
transferring, by the processor, the mapping table read command to one of the memory channels which corresponds to the address mapping table section, in order to process the mapping table read command

3. The control method according to claim 2, further comprising (e):
determining, by each memory channel controller corresponding to each memory channels, whether there is an arbitrary data read command to be preferentially processed, and
preferentially processing, by each memory channel controller, the data read command when both of the data read command and the mapping table read command are determined to be processed by each memory channel controller.

4. The control method according to claim 3,
wherein each of the memory channels has first and second command queues,
wherein the (c) further comprises:
storing the data read command in the first command queue of the memory channel corresponding to the physical address, and
transferring, by the processor, the data read command to the memory channel corresponding to the physical address in order to process the data read command, and
wherein the (d) further comprises:
storing the mapping table read command in the second command queue of the memory channel corresponding to the address mapping table section, and
transferring, by the processor, the mapping table read command to the memory channel corresponding to the address mapping table section in order to process the mapping table read command.

5. The control method according to claim 4, wherein the (e) further comprises:
determining, by each memory channel controller, whether there is an arbitrary data read command to be preferentially processed by determining whether the first command queue is empty,
processing, by each memory channel controller, the command in the first command queue when the first command queue is not empty, and
processing, by each memory channel controller, the command in the second command queue when the first command queue is empty.

6. The control method according to claim 3,
wherein each of the memory channels comprises a command queue,
wherein the (c) further comprises:
giving a first priority to the data read command,
storing the data read command in the command queue of the memory channel corresponding to the physical address, and
transferring, by the processor, the data read command to the memory channel corresponding to the physical address in order to process the data read command, and
wherein the (d) further comprises:
giving a second priority to the mapping table read command,
storing the mapping table read command in the command queue of the memory channel corresponding to the address mapping table section, and
transferring, by the processor, the mapping table read command to the memory channel corresponding to the address mapping table section in order to process the mapping table read command

7. The control method according to claim 6, wherein the (e) further comprises:
determining, by each memory channel controller, whether there is an arbitrary data read command to be preferentially processed by determining whether the command with the first priority is present in the command queue,
processing, by each memory channel controller, the command with the first priority in the command queue when the command with the first priority is present in the command queue, and
processing, by each memory channel controller, the command with the second priority in the command queue when the command with the first priority is not present in the command queue.

8. The control method according to claim 2,
wherein the (d) further comprises setting the read request in a first state,
wherein the control method further comprises:
(f) reading the read request in the first state through the (a) after the mapping table read command is processed due to the (d),
(g) generating a first data read command corresponding to the read request in the first state through the (b) and the (c),
(h) transferring, by the processor, the first data read command to one of the memory channels which corresponds to the physical address, in order to process the first data read command, and
(i) additionally setting the read request in a second state.

9. The control method according to claim 2,
wherein the (d) further comprises transferring the read request to one queue,
wherein the control method further comprises:
(j) reading the host read request of the queue through the (a) after the mapping table read command is processed,
(k) generating a first data read command corresponding to the host read request of the queue through the (b) and the (c), and
(l) transferring, by the processor, the first data read command to one of the memory channels which corresponds to the physical address, in order to process the first data read command.

10. A recording medium that records a program code for controlling a memory device to execute the control method according to claim 1.

11. A memory device comprising:
a cache;
an address translator configured to:
determine whether a logical address corresponding to a host read request is present in the cache,
generate a data read command according to the host read request by translating the logical address into a physical address based on address mapping data in the cache when the logical address corresponding to the host read request is present in the cache, and
transfer the data read command to one of a plurality of memory channels which corresponds to the physical address, in order to process the data read command; and
a plurality of memory channel controllers each corresponding to one of the memory channels and configured to process a command.

12. The memory device according to claim 11, wherein when the logical address corresponding to the host read request is not present in the cache, the address translator further:
finds an address mapping table section corresponding to the logical address based on the logical address,
generates a mapping table read command according to the host read request, and
transfers the mapping table read command to one of the memory channels which corresponds to the address mapping table section, in order to process the mapping table read command.

13. The memory device according to claim 12, wherein each of the memory channel controllers:
determines whether there is an arbitrary data read command to be preferentially processed, and
preferentially processes the data read command when both of the data read command and the mapping table read command are determined to be processed by the memory channel controller.

14. The memory device according to claim 13,
wherein each of the memory channels has first and second command queues,
wherein the address translator:
stores the data read command in the first command queue of the memory channel corresponding to the physical address, and
transfers the data read command to the memory channel corresponding to the physical address in order to process the data read command,
wherein the address translator:
stores the mapping table read command in the second command queue of the memory channel corresponding to the address mapping table section, and
transfers the mapping table read command to the memory channel corresponding to the address mapping table section in order to process the mapping table read command

15. The memory device according to claim 14, wherein the memory channel controller:
determines whether there is an arbitrary data read command to be preferentially processed by determining whether the first command queue is empty,
processes the command in the first command queue when the first command queue is not empty, and
processes the command in the second command queue when the first command queue is empty.

16. The memory device according to claim 13,
wherein each of the memory channels comprises a command queue,
wherein the address translator:
gives a first priority to the data read command,
stores the data read command in the command queue of the memory channel corresponding to the physical address, and
transfers the data read command to the memory channel corresponding to the physical address in order to process the data read command,
wherein the address translator:
gives a second priority to the mapping table read command,
stores the mapping table read command in the command queue of the memory channel corresponding to the address mapping table section, and
transfers the mapping table read command to the memory channel corresponding to the address mapping table section in order to process the mapping table read command

17. The memory device according to claim 16, wherein the memory channel controller:
determines whether there is an arbitrary data read command to be preferentially processed by determining whether a command with the first priority is present in the command queue,
processes the command with the first priority in the command queue when the command with the first priority is present in the command queue, and
processes the command with the second priority in the command queue when the command with the first priority is not present in the command queue.
